(19) United States
(12) Patent Application Publication
(10) Pub. No.: US 2025/0354861 A1
(43) Pub. Date: Nov. 20, 2025

(54) METHOD AND SYSTEM FOR MEASURING SPATIAL LIGHT FIELD OF LUMINAIRE

(71) Applicant: HANGZHOU EVERFINE PHO-E-INFO CO., LTD., Hangzhou (CN)

(72) Inventors: Jiangen PAN, Hangzhou (CN); Qian LI, Hangzhou (CN)

(73) Assignee: HANGZHOU EVERFINE PHOTO-E-INFO CO., LTD., Hangzhou (CN)

(21) Appl. No.: 19/209,973

(22) Filed: May 16, 2025

(30) Foreign Application Priority Data
May 17, 2024 (CN) 202410617151.5

(51) Int. Cl. G01J 1/02; G01J 1/04; G01J 1/42; G01J 1/44

(52) U.S. Cl. CPC G01J 1/0242; G01J 1/0474; G01J 1/4228; G01J 1/44; G01J 2001/4233; G01J 2001/444

(57) ABSTRACT

Illuminance distributions on illuminated surfaces within two or more local angular intervals in the far-field of a measured luminaire are measured by a first imaging measurement device and integrated to obtain full spatial light field information of the measured luminaire. Meanwhile, light-emitting surface images of the measured luminaire in two or more poses are obtained by a second imaging measurement device, so as to obtain more accurate pose information of the luminaire when measured by the first imaging measurement device; ray set information of the measured luminaire is calculated from the light-emitting surface images at all angles, and more spatial light field distribution data is further derived. The system includes a rotatable table for installing the measured luminaire, a diffusing screen, the first imaging measurement device, the second imaging measurement device, and a data transmission and reception control unit.

### TECHNICAL FIELD

The present invention relates to the technical field of optical radiation measurement, specifically to a method and system for measuring the spatial light field of a luminaire.

### BACKGROUND

Spatial light field distribution of a luminaire is its important optical performance. It is a common practice in the industry to measure spatial luminous intensity distribution with a goniophotometer. The goniophotometer consists of a rotatable table and an illuminance detector, where the illuminance detector measures illuminance at a distance from a measured luminaire and obtains a luminous intensity through the inverse square law, referred to as a “scanning method”. Alternatively, light emitted by the luminaire is projected onto a diffusing screen, luminance distribution of the light reflected on the diffusing screen is measured through an imaging measurement device, and the luminous intensity distribution is further calculated through a relationship between luminance, illuminance, and luminous intensity, referred to as an “imaging method”.

The scanning method has high accuracy in photometric measurement, but it is slow and difficult to achieve high angular resolution, usually up to 0.1°. However, some occasions (such as determining a cut-off line of a vehicle headlamp) require a resolution of 0.01° or even higher. Restricted by the receiving surface size and sensitivity of the detector, the conventional scanning method is almost impossible to achieve. The imaging method has a relatively fast measurement speed and can achieve a high angular resolution on the premise of sufficient pixels and good imaging quality in the imaging measurement device. However, the imaging method has lower accuracy, mainly due to the presence of stray light, in addition to low spectral matching and linearity of the imaging measurement device compared to single-channel illuminance detectors. Generally, when the imaging method is used for measurement in a large space, almost all rays emitted by the measured luminaire are projected onto the diffusing screen, secondary or multiple reflections happen in space, and crosstalk also occurs on the surface of a sensor inside the imaging measurement device, resulting in stray light. Especially the measurement of a dark region is prone to interference by the stray light. To solve this problem, some solutions propose to correct the imaging measurement device with a stray light algorithm, and some use an illuminance meter for scanning and measurement in a sensitive region based on the imaging method. However, these solutions do not fundamentally solve the problem, and the measurement speed and angular resolution of the latter are greatly affected.

Moreover, in recent years, large multi-module luminaires, such as multi-layer marine lights and matrix headlights and full-width LED light bars, have emerged. In these luminaires, a single module serves as an independent evaluation unit, the luminous intensity distribution of each module is measured for corresponding qualification determination; or the luminous intensity distribution of each module is measured separately, and then the luminous intensity distribution of the entire luminaire is obtained by superimposition. In the measurement of luminous intensity distribution of each module, its photometric center needs to be aligned with the rotation center of the goniophotometer, requiring the goniophotometer to have sufficient size and weight capacity for fixing the photometric center to the rotation center. Moreover, the center alignment is difficult to adjust and prone to deviation due to misalignment.

On the other hand, the measurement of light distribution also needs to be combined with practical applications. Conventional measurement of luminous intensity distribution is based on the inverse square law. In practical applications, these data are also based on this law for illumination design. However, in actual implementation, the luminaire may be relatively close to an illuminated surface, and the inverse square relationship is difficult to establish. The luminous intensity distribution of the luminaire cannot fully express spatial light field information of the luminaire.

### SUMMARY

To overcome the shortcomings of existing technologies, the present invention provides a method and system for measuring the spatial light field of a luminaire, which can achieve high-precision and high-resolution rapid measurement of the full spatial light field. Specific technical solutions are as follows.

A method for measuring the spatial light field of a luminaire is provided, where illuminance distributions on illuminated surfaces within two or more local angular intervals in the far-field of a measured luminaire are measured and integrated to obtain full spatial light field information of the measured luminaire, where specific steps are as follows:

S1: installing the measured luminaire on a rotatable table, wherein only a portion of light emitted by the measured luminaire illuminates a diffusing screen in the far-field space, while the remaining light is blocked by a stray light eliminating device;

S2: aligning a first imaging measurement device with the diffusing screen to measure the illuminance distribution thereon, and aligning a second imaging measurement device with the measured luminaire to obtain a light-emitting surface image of the measured luminaire;

S3: rotating the measured luminaire through the rotatable table to change the pose of the measured luminaire, and repeating step S2 for measurement in two or more poses; and

S4: integrating the light-emitting surface images of the measured luminaire in different poses and the illuminance distributions on the diffusing screen to calculate a full spatial luminous intensity distribution of the measured luminaire.

In the present invention, “integrating” means “combining”, “splicing”, “merging”, or the like. Illuminance distributions on illuminated surfaces within two or more local angular intervals in the far-field of a measured luminaire are measured by a first imaging measurement device and then integrated to obtain a full spatial luminous intensity distribution of the measured luminaire.

Step S4 may be implemented in various ways. For instance, as one way, an illuminance distribution measurement value of the measured luminaire in one pose is calculated as follows: performing coordinate transformation based on the pose information of the measured luminaire, calculating a spatial angle corresponding to each point on the diffusing screen with the reference center of the measured luminaire as the origin, calculating a distance between each point on the diffusing screen and the reference center of the measured luminaire, calculating a corresponding luminous intensity value based on the inverse square law, obtaining the spatial luminous intensity distribution of the measured luminaire in a local angular interval corresponding to the pose; and integrating the obtained spatial luminous intensity distributions in the local angular intervals in all poses to obtain the full spatial luminous intensity distribution. Such a way of implementing Step S4 is described in detail in the disclosure below.

In the present invention, the illuminance distribution of the measured luminaire in a local angular interval is measured through the first imaging measurement device, the measured luminaire is driven to rotate through the rotatable table for light distribution measurement in different spatial angular regions, and the illuminance distributions are integrated and calculated to form full spatial light field data. The diffusing screen only receives light within the local spatial angular interval in a single measurement, while a large amount of light in non-measurement angular regions is blocked by the stray light eliminating device and will not be reflected onto the diffusing screen or inside the imaging measurement device to produce stray light interference, thereby fundamentally solving the problem of stray light in the imaging method. The stray light eliminating device in the present invention includes two or more groups of stray light eliminating apertures. The imaging measurement device in the present invention has a two-dimensional array detector, where each pixel corresponds to a designated position on the diffusing screen, and each position corresponds to a spatial position coordinate (spatial angle), that is, the local angular interval is divided by more than one million pixels. Therefore, measurement data has extremely high spatial resolution. Compared to conventional measurement of illuminance (luminous intensity) by a single-channel photometer through rotational scanning, the present invention has a larger scanning step, and therefore, the measurement speed is quite fast and the measurement is efficient. The second imaging measurement device in the present invention scans and measures the light-emitting surface images of the measured luminaire, providing richer position information and light information for the integration and calculation of spatial light field data, thereby further improving the reliability of measurement and the integrity of spatial light field data.

As a supplementary explanation, the first imaging measurement device measures the illuminance distribution based on the principle that the diffusing screen serves as a Lambert reflector, the illuminance of light illuminating the diffusing screen is proportional to the luminance of the reflected or transmitted light, and the same surface element has the same luminance in all directions. Therefore, as long as the luminance distribution of the diffusing screen is accurately obtained, the illuminance distribution of the light illuminating the diffusing screen can be obtained. This technical solution can further use a standard source to calibrate the first imaging measurement device. As the spatial luminous intensity distribution of the standard source, the distance from the diffusing screen, and pose of the light source are already known, its illuminance distribution on the diffusing screen can be accurately obtained, so as to calibrate the first imaging measurement device.

As a supplementary explanation, the full spatial light field information does not refer to the entire 4π space or infinite plane, but rather to the entire space of interest for measurement. For example, many luminaires only emit light forward, so only the 2π angle space in front of the light-emitting surface is of interest. For a luminaire, its most basic spatial light field information is spatial luminous intensity distribution, often represented as I(θ,φ), where/represents a luminous intensity symbol, (θ,φ) represents directional coordinates with a photometric center of the measured luminaire as an origin, and the photometric center is sometimes referred to as a reference center and represented as a symbol C. According to CIE 121 and other documents, the photometric center needs to be determined based on the type of the light-emitting surface of the measured luminaire (such as transparent or frosted, and the shape of the light-emitting surface). The light field information may be further extended to include illuminance distribution on a certain plane or curved surface in the space, ray set data, etc. The illuminance distribution may be represented as F(x,y,z,θ,φ), where E represents an illuminance symbol, (x,y,z) represents spatial position coordinates, and (θ,φ) represents a normal direction of the surface element. Generally, a reference point on the measured luminaire is designated as the origin, where the reference point may be the center of the light-emitting surface. The ray set data is represented as Φ(x,y,z,θ,φ), where Φ represents a ray flux, (x,y,z) represents coordinates of a point in ray, usually with a point on the measured luminaire as the origin, and (θ,φ) represents a ray direction. For the convenience of description, the above photometric center, reference point, and reference center are collectively referred to as a reference center, denoted by C. In specific applications, the above coordinate symbols are represented by different subscripts based on the coordinate system used and the represented object. Details will be explained below.

As a supplementary explanation, the rotation and/or translation of the measured luminaire driven by the rotatable table is achieved through a motion mechanism on the rotatable table. The pose of the measured luminaire generally includes position and attitude. In the world coordinate system, the pose information of the measured luminaire may be represented as (x_{w,c}, y_{w,c}, z_{w,c}, θ_{w,c}, φ_{w,c}), where (x_{w,c}, y_{w,c}, z_{w,c}) represents position deviation of the reference center C of the measured luminaire from the origin of world coordinates, and (θ_{w,c}, φ_{w,c}) represents deviation of the light-emitting surface of the measured luminaire (normal) from a reference direction. Generally, the reference direction is defined as the center normal direction of the diffusing screen. The origin of world coordinates is represented by O, which is a fixed point in space. Generally, the intersection point of two rotation axes of the rotatable table, namely, the center of rotation, is designated as the origin.

As a technical solution, in step S3, the rotatable table provides rotation information of the measured luminaire; and in step S4, pose information of the measured luminaire is calculated by combining the rotation information of the measured luminaire and analysis on the light-emitting surface images, that is, corresponding pose information of the measured luminaire when the first imaging measurement device measures the illuminance distributions in local angular intervals is obtained. In this solution, the rotatable table can provide an angle of rotation of the measured luminaire relative to the diffusing screen through an encoder, an inclinometer, a gyroscope, or the like, denoted as (ε, η), which is important information representing the pose of the measured luminaire. In the process of calculating the pose information of the measured luminaire by image analysis, pixels of the second imaging measurement device can be pre-calibrated by an object with known installation position, angle, and size information. The method for determining the reference center of the measured luminaire includes, but is not limited to, methods such as feature point recognition or peripheral feature region recognition; and the deviation angle information of the measured luminaire relative to the reference direction can also be obtained by identifying feature points on the measured luminaire.

In conventional technologies, when the reference center C of the measured luminaire coincides with the rotation center O of the rotatable table, and the normal direction of the light-emitting surface of the luminaire is the same as the reference direction of the rotatable table (the center normal direction of the diffusing screen), the relative rotation angle can be directly used to represent the direction of luminous intensity. However, when the measured luminaire is relatively heavy, deviation may occur during rotation due to insufficient rigidity of the rotatable table. In this case, angle verification and correction can be carried out in conjunction with the light-emitting surface images. When the light-emitting surface of the measured luminaire is relatively complex to determine the reference center C (such as the presence of a plurality of light-emitting modules or the presence of a complex lens in the measured luminaire) or the luminaire is too large to make its reference center C coincide with the rotation center O, the light-emitting surface images obtained by the second imaging measurement device at various relative rotation angles play a more important role in locating the pose of the measured luminaire more accurately. For example, when the measured luminaire is installed on the rotatable table, an initial position of the reference center of the measured luminaire and an initial direction of the normal of the light-emitting surface are adjusted and determined through the light-emitting surface images. The initial pose is denoted as (x_{w0}, y_{w0}, z_{w0}, θ_{w0}, φ_{w0}). After rotating a certain angle (ε, η), position coordinates of the reference center are calculated as shown in equation (1) and the angle of the light-emitting surface is shown in equation (2).

$$( [ \begin{matrix}{x}_{W , C} \\ {y}_{W , C} \\ {z}_{W , C}\end{matrix} ] ) = [ \begin{matrix}cos ε & - sin ε & 0 \\ sin ε & cos ε & 0 \\ 0 & 0 & 1\end{matrix} ] \cdot [ \begin{matrix}cos η & 0 & sin η \\ 0 & 1 & 0 \\ - sin η & 0 & cos η\end{matrix} ] \cdot ( {x}_{W 0} , {y}_{W 0} , {z}_{W 0} ) \qquad ( 1 )$$

$$[ \begin{matrix}{θ}_{W , C} \\ {φ}_{W , C}\end{matrix} ] = [ \begin{matrix}{θ}_{W 0} + ε \\ {φ}_{W 0} + η\end{matrix} ] \qquad ( 2 )$$

At this position, the position of the reference center and the angle of the light-emitting surface are analyzed through the light-emitting surface images captured by the second imaging measurement device. Pixel coordinates of the second imaging measurement device are calibrated, where the angle (θ₂, φ₂) formed by the line connecting a point in space to the second imaging measurement device corresponds one to one with the pixel coordinates (i₂, j₂) of the second imaging measurement device. Because the position of the second imaging measurement device is fixed, the actual position of the reference center can be accurately calculated and checked for expectation. If there is a deviation in the pose actually observed through the light-emitting surface images, the reference center and luminous intensity distribution calculation results need to be adjusted and corrected. Further, by scanning and measuring the light-emitting surface images at various angles, the morphology of the light-emitting surface of the measured luminaire can be modeled to confirm the position of the reference center C more accurately, thereby obtaining the spatial light field information of the measured luminaire more accurately.

As a further definition of the above technical solution, a third imaging measurement device at a certain distance from the second imaging measurement device is further used, the third imaging measurement device is aligned with the measured luminaire at another position to obtain auxiliary light-emitting surface images of the measured luminaire, and the pose information of the measured luminaire is obtained through an image recognition algorithm in conjunction with the auxiliary light-emitting surface images and the light-emitting surface images obtained in step S2. In this solution, the second imaging measurement device and the third imaging measurement device simultaneously obtain light-emitting surface images, thereby determining the pose information of the measured luminaire more accurately through an algorithm based on binocular recognition.

As a technical solution, in step S4, an illuminance distribution measurement value of the measured luminaire in one pose is calculated as follows: performing coordinate transformation based on the pose information of the measured luminaire, calculating a spatial angle corresponding to each point on the diffusing screen with the reference center of the measured luminaire as the origin, calculating a distance between each point on the diffusing screen and the reference center of the measured luminaire, calculating a corresponding luminous intensity value based on the inverse square law, obtaining the spatial luminous intensity distribution of the measured luminaire in a local angular interval corresponding to the pose; and integrating the obtained spatial luminous intensity distributions in the local angular intervals in all poses to obtain the full spatial luminous intensity distribution. The far-field space refers to the space far enough from the measured luminaire to treat it as a point source. For example, according to CIE 121 and other documents, for the measured luminaire with an emission pattern similar to cosine distribution, this distance is at least 5 times the maximum size of the light-emitting surface. If the measured luminaire has a narrow beam angle, this distance is at least 10 times the maximum size of the light-emitting surface. The measured illuminance of the measured luminaire beyond this distance can be converted into a luminous intensity value based on the inverse square law. As shown in FIG. 1, it is assumed that the reference center of the measured luminaire is located at the rotation center O of the rotatable table, and the center normal of the diffusing screen passes through the center O of the rotatable table. If the distance between the reference center of the measured luminaire and the diffusing screen satisfies the inverse square law, the illuminance at any point on the screen (such as point A) can be obtained through equation (3):

$$E ( {x}_{M , {A}^{,}} {y}_{M , A} ) = I ( {θ}_{C , A} , {φ}_{C , A} ) \cdot {cos}^{3} α / {d}^{2} \qquad ( 3 )$$

In the equation,/represents the luminous intensity value, d represents the distance between the center O of the rotatable table and the center M of the diffusing screen, αrepresents an angle between the line connecting point A and the center O of the rotatable table and the center normal and can be obtained through equation (4), and (θ_{C,A}, φ_{C,A}) represents a direction corresponding to point A with the reference center of the measured luminaire as the origin. When the direction of the measured luminaire (0,0) coincides with the center normal of the diffusing screen, θ=α.

$$α = arctan \frac{\sqrt{{x}_{M , A}^{2} + {y}_{M , A}^{2}}}{d} \qquad ( 4 )$$

As shown in FIG. 2, when the reference center C of the measured luminaire deviates from the center O of the rotatable table, the distance between the reference center C and the diffusing screen may change. In this case, a new coordinate position relationship needs to be established, and luminous intensity distribution information with the reference center C as the origin is obtained through coordinate transformation. The relationship between the illuminance and luminous intensity at point A is shown in equation (5).

$$E ( {x}_{M , A} , {y}_{M , A} ) = I ( {θ}_{C , A} , {ϕ}_{C , A} ) \cdot {cos}^{3} α / {( d - {z}_{W , C} )}^{2} \qquad ( 5 )$$

In the equation, I represents the luminous intensity value, α represents an angle between the line connecting point A and the reference center C of the measured luminaire and the normal of the diffusing screen, the reference center is represented as (x_{w,c}, y_{w,c}, z_{w,c}) in the world coordinate system with the center of the rotatable table as the origin, and a can be obtained through equation (6):

$$α = arctan \frac{\sqrt{Δ {x}_{A {C}^{′}}^{2} + Δ {y}_{A {C}^{′}}^{2}}}{d - {z}_{W , C}} \qquad ( 6 )$$

Where ΔX_{AT′} and ΔY_{AT′} represent coordinate differences between the projection C′ of the reference center C of the measured luminaire on the diffusing screen and point A in the coordinate system of the diffusing screen.

The luminous intensity direction (θ_{C,A}, φ_{C,A}) corresponding to point A with the reference center of the measured luminaire as the origin is calculated through coordinate vector transformation from the \vec{CA} direction and the pose of the measured luminaire (θ_{W,C}, φ_{W,C}).

As a technical solution, in step S4, the light-emitting surface image of the measured luminaire in one pose is calculated as follows: converting the light-emitting surface image into regional ray set information composed of several ray data, where the ray data includes a ray direction, position coordinates of a point in ray, and a ray flux; and integrating the corresponding regional ray set information in all poses to obtain full ray set information. In this technical solution, the light-emitting surface image is a light-emitting surface luminance image or can be converted into a light-emitting surface luminance image; and by analyzing the luminance images in various directions, the ray set information of the measured luminaire in the full space is obtained.

As a further definition of the above technical solution, the ray data corresponds to pixels in the light-emitting surface image; the ray direction is determined based on the pose information of the measured luminaire, the pose of the second imaging measurement device, and pixel coordinates in the second imaging measurement device; the position coordinates of the point in the ray are determined by the pose information of the measured luminaire and the pose of the second imaging measurement device; and the ray flux is determined by pixel response, pixel area, and a spatial angle.

The luminance is defined as a luminous flux generated by unit surface elements on the light-emitting surface within a unit solid angle, expressed as equation (7):

$$L ( {x}_{s} , {y}_{s} , {z}_{s} , {θ}_{s} , {ϕ}_{s} ) = \frac{d Φ ( {ϑ}_{s} , {ϕ}_{s} )}{dA ( {x}_{s} , {y}_{s} , {z}_{s} ) \cdot cos {ϑ}_{s} \cdot d Ω ( {ϑ}_{s} , {ϕ}_{s} )} \qquad ( 7 )$$

Where dΦ(θₛ, φₛ) represents the luminous flux of a surface element dA(xₛ, yₛ, zₛ) on the light-emitting surface of the measured luminaire within the solid angle dΩ(θₛ, φₛ), the position coordinates of the surface element are (xₛ, yₛ, zₛ), and the ray direction is (θₛ, φₛ).

Based on the response of one pixel in the luminance image obtained by the second imaging measurement device, a corresponding ray data can be calculated as follows: the entrance pupil position of the second imaging measurement device corresponds to a point position in the ray, the ray direction is calculated from the pose of the measured luminaire and the pixel coordinates, the ray flux corresponds to the response value of the pixel, the size of the surface element used to calculate the flux is related to the scanning angular interval measured by the second imaging measurement device and corresponds to a surface element region on a scanning sphere, and the solid angle element corresponds to the solid angle of the pixel relative to the lens. Due to the reversibility of ray, once the ray direction and the coordinates of a point in the ray are determined, the coordinates of any other point in the ray can be obtained. In practical use, the intersection point between the ray and the light-emitting surface of the measured luminaire is often used to represent coordinates.

As a further definition of the above technical solution, in step S4, photometric parameters are derived and calculated based on the full ray set information of the measured luminaire, where the photometric parameters include, but are not limited to, illuminance distribution of a specified region, luminous intensity distribution, and total luminous flux or regional luminous flux. In this technical solution, many photometric parameters can be derived after the full spatial ray set information is obtained. For example, the illuminance value of a specified surface element in the space can be obtained by accumulating ray fluxes that intersect the surface element in the ray set; the luminous intensity value within a specified solid angle element is obtained by accumulating ray fluxes within the solid angle element; and the luminous flux can be obtained by accumulating all the ray fluxes.

As a technical solution, one or more optical radiation probes are further used to receive light from the measured luminaire; a same calibration light source or the measured luminaire is measured by the optical radiation probes, the first imaging measurement device, and the second imaging measurement device, respectively; and measurement or calculation values of the first imaging measurement device and/or the second imaging measurement device are calibrated against the measurement or calculation values of the optical radiation probes. The above optical radiation probes include, but are not limited to, photometric probes, radiometric probes, spectral radiometers, and sampling devices thereof. Generally speaking, the measurement values of single-channel optical radiation probes have higher measurement accuracy than the imaging measurement devices, but their disadvantage is excessively slow measurement speed. Therefore, in some occasions requiring high accuracy, the measurement values of the optical radiation probes can be used as a supplement. For example, in the calibration phase, the same calibration light source is used to calibrate the measurement or calculation values of the first imaging measurement device and/or the second imaging measurement device based on the measurement values of the optical radiation probes.

There are at least two methods to calibrate the first imaging measurement device: i, the beam angle of the calibration light source is greater than the aperture angle of the diffusing screen relative to the rotation center, that is, when the calibration light source is facing the diffusing screen, the resulting light spot can completely cover the diffusing screen, whereby the illuminance of each point on the diffusing screen is calibrated through the known spatial luminous intensity distribution of the calibration light source; and ii, the calibration light source is a conventional luminous intensity standard luminaire, only the luminous intensity in the direction of the optical axis is accurately known, the calibrated imaging measurement system has undergone flat-field correction before calibration to have consistent illuminance response at any point, the calibration light source is adjusted during calibration to align its optical axis with the determined point on the diffusing screen, then the illuminance response at this point is calibrated, and the illuminance responses at other positions are calibrated proportionally. The former calibration method is relatively simple, while the latter method can obtain luminous intensity values with lower uncertainty, but may be affected by non-cosine errors in the diffusing screen. For the calibration of the second imaging measurement device, the selected calibration light source should have a uniform light-emitting surface as much as possible, and the luminance distribution of the light-emitting surface should be known. In conclusion, a more convenient calibration method is to use a uniform surface light source with known luminance to generate a light spot larger than an imaging measurement region on the diffusing screen. In order to further improve the measurement accuracy of the imaging measurement device, an adjustable calibration light source or a plurality of calibration light sources can be used for calibration. For example, in order to reduce linear errors of the imaging measurement device, the calibration light source can be used to generate different levels of illuminance distribution and/or surface luminance distribution; and in order to reduce spectral mismatch errors of the imaging measurement device, the calibration light source can be used to generate different spectral output beams.

As a further definition of the above technical solution, in step S4, measurement values of the first imaging measurement device are compared with the photometric parameters derived and calculated from the full ray set information, and the full ray set information is corrected based on the comparison results. In fact, there is a mutual verification relationship between the two, but due to the complex derivation and calculation process of the second imaging measurement device and the deviation of the absolute luminance value when directly measuring the measured object, the use of the measurement values of the first imaging measurement device to correct the measurement derivation values of the second imaging measurement device can improve the measurement accuracy.

As a technical solution, a speed photometer is used to measure changes of illuminance over time, so as to calculate a light modulation period, where measurement integration time of the first imaging measurement device and/or the second imaging measurement device is an integer multiple of the modulation period. When the light emitted by the measured luminaire has modulation characteristics, the integration time of the imaging measurement device must be an integer multiple of the modulation period, otherwise significant instability may occur. By measuring the light modulation period through the speed photometer, it can help the imaging measurement device choose the appropriate integration time. It is worth mentioning that there may be a plurality of light sources in the measured luminaire, and the modulation periods of the light sources for emitting in different directions may vary. In this case, the light modulation period in each angular region can be first obtained through the speed photometer, and the integration time can be used for measurement when the light in the corresponding region is scanned onto the diffusing screen.

As a technical solution, the first imaging measurement device has a chromaticity measurement function and outputs chromaticity of each point on the diffusing screen in the measurements of steps S2 and S3, and varying chromaticity parameters over spatial angle are calculated in step S4. The chromaticity parameter serves as a supplement to the photometric parameters, providing richer measurement data.

As a technical solution, a bidirectional scattering distribution function (or bidirectional reflection distribution function or bidirectional transmission distribution function) of the diffusing screen is obtained, and the local regional illuminance distribution obtained by the first imaging measurement device is corrected through the bidirectional scattering distribution function.

The premise of using the imaging method is that the diffusing screen is a uniform cosine screen, that is, the illuminance of light in any direction can produce equal luminance in all directions. In this case, the illuminance E at a certain point on the diffusing screen is proportional to the luminance L, that is, E=(L·π)/ρ, where ρ represents a reflectance ratio. However, in actual measurements, when the incident angle of light is relatively large or the luminance measurement angle is relatively large, it is difficult to ensure the cosine characteristics of the diffusing screen, resulting in significant errors. In order to reduce or avoid the impact of non-cosine reflection/transmission of the diffusing screen, the bidirectional reflection/transmission distribution function of the diffusing screen can be measured and used to correct the luminous intensity value of the measured luminaire in step S4. As shown in FIG. 3, the bidirectional reflection/transmission distribution function ρ(ωᵢ, ωₛ) refers to the distribution of reflectance or transmittance produced by incident light from different directions onto the diffusing screen with respect to angle, as shown in equation (8).

$$ρ ( {ω}_{i} , {ω}_{s} ) = {dL}_{s} ( {ω}_{s} ) / {dE}_{i} ( {ω}_{i} ) \qquad ( 8 )$$

In the equation, ωᵢ represents a direction of incident light, specifically (θᵢ, φᵢ) in FIG. 3, where (θᵢ, φᵢ) represents a zenith angle and an azimuth angle of the incident light; ωₛ represents a direction of scattered light, specifically represented by (θₛ, φₛ) in FIG. 3, where (θₛ, φₛ) represents a zenith angle and an azimuth angle of the scattered light; dLₛ(ωₛ) represents a differential luminance in the direction of scattered light (θₛ, φₛ), and dEᵢ(ωᵢ) represents a differential illuminance on the surface of the diffusing screen in the direction of incident light (θᵢ, φᵢ).

Through the equation (8), the imaging measurement device can obtain illuminance values

$$E ( x , y ) = \frac{L ( x , y ) \cdot π}{ρ ( {ω}_{i} , {ω}_{s} )} \qquad ( 9 )$$

Where (x,y) represents coordinates of a point on the diffusing screen, E(x,y) represents an illuminance of the position (x,y), and L(x,y) represents a luminance of the position (x,y). After this point is determined, the corresponding direction of incident light ωᵢ, i.e. (θᵢ, φᵢ), can be uniquely determined. According to the measurement arrangement, the direction of incidence of this point into the imaging measurement device ωₛ, i.e. (θₛ, φₛ), can also be determined.

As a technical solution, in the measurement process of step S3, a preliminary analysis is carried out based on the illuminance distribution on the diffusing screen that is collected by the imaging measurement device. When the luminance and darkness of the illuminance distribution change dramatically, the rotatable table is controlled, so that bright and dark regions of the light emitted by the measured luminaire are separately illuminated onto the diffusing screen for measurement. This technical solution implements image recognition and analysis during the scanning measurement process for separating the measurement of the dark region and the luminance, thereby reducing stray light errors caused by the secondary reflection of bright light entering the dark region during measurement.

As a technical solution, during the scanning measurement process in step S3, there is an overlap region between two measurements of the first imaging measurement device; and in step S4, illuminance distribution data of the overlap region is analyzed, and error factors are analyzed and corrected, where the error factors include, but are not limited to, stray light, light blocking, or angular accuracy.

As a technical solution, the angular resolution of each region within the field of view of the first imaging measurement device and/or the second imaging measurement device is measured, and the pixel measurement values are merged based on an angular resolution threshold. The angular resolution that can be achieved by the method of the present invention during measurement is not equivalent to the pixels of the imaging measurement device, but more related to the angular resolution of the entire optical system. High pixels do not represent high resolution, but instead increase useless information and occupy a large amount of memory. An angular resolution map card is set on the surface of the diffusing screen, and the imaging measurement device is used to obtain images for analyzing a minimum distinguishable line pair 1 p/mm. The angular resolutions of the imaging measurement device in various regions of the diffusing screen are obtained through the line pair based on a trigonometric function (there may be differences in the center and periphery). In the actually obtained illuminance distribution, the pixel responses within the distinguishable angular interval are merged and calculated based on the angular resolutions, where the illuminance is represented by an average value of pixels within the interval, and the angle may be a center value.

Based on the above measurement method, the present invention provides a system for measuring the spatial light field of a luminaire, including a rotatable table for installing a measured luminaire, a diffusing screen arranged opposite to the rotatable table, a first imaging measurement device, a second imaging measurement device, and a data transmission and reception control unit; the first imaging measurement device is aligned with the diffusing screen for measurement, and the second imaging measurement device is aligned with the measured luminaire; the rotatable table has a motion mechanism that drives the measured luminaire to rotate; two or more groups of stray light eliminating apertures are arranged between the rotatable table and the diffusing screen; and the first imaging measurement device, the second imaging measurement device, and the motion mechanism are all in communication connection with the data transmission and reception control unit.

The first imaging measurement device in the present invention has a two-dimensional array detector for measuring the illuminance distribution of the light projected by the measured luminaire onto the diffusing screen, each pixel of the array detector corresponds to a designated position of the diffusing screen, and each position corresponds to a spatial angle; the rotatable table drives the measured luminaire to rotate and/or translate, thereby achieving light measurement in different spatial regions; and the second imaging measurement device provides more detailed and accurate pose information for the first imaging measurement device. Only the illuminance distribution within a local angular interval is measured, so the incident angle on the diffusing screen is greatly reduced, which can greatly reduce errors caused by the non-cosine characteristics of the diffusing screen. Meanwhile, the relatively small screen region also greatly reduces stray light interference caused by secondary reflection, thereby greatly improving the measurement accuracy.

As a further definition and improvement of the above technical solution, the light hole of the stray light eliminating aperture is slightly greater than the cross-section of the beam at its position, or the light hole of the stray light eliminating aperture is slightly greater than the flare angle of a line connecting the outer side of the maximum measurable light-emitting surface and the edge of a measurement region of the diffusing screen.

As a technical solution, the above diffusing screen is a diffuse reflection screen, and the first imaging measurement device is arranged on the side close to the measured luminaire; or the above diffusing screen is a diffuse transmission screen, and the first imaging measurement device is arranged on the side remote from the measured luminaire. When the diffusing screen is the diffuse reflection screen, the first imaging measurement device may be arranged near the measured luminaire without occupying additional measurement space. When the diffusing screen is the diffuse transmission screen, the imaging measurement device is preferably arranged on the other side of the diffuse transmission screen and aligned with the diffuse transmission screen, remote from the measured luminaire. The light emitted by the measured luminaire is projected onto the screen for imaging, and its transmitted light diffuses towards the other side and is then received by the imaging measurement device. This technical solution can avoid distortion errors caused by the tilting placement of the imaging measurement device to avoid blocking the light emitted by the measured luminaire. During measurement, a suitable diffusing screen can be selected based on actual measurement needs.

As a technical solution, the system includes a shading tunnel, the shading tunnel is arranged between the rotatable table and the diffusing screen, and the stray light eliminating apertures are arranged in the shading tunnel. The arrangement of the shading tunnel can further eliminate stray light interference. On the other hand, the wrapping shading tunnel can reduce the entire measurement space, and other regions beyond the shading tunnel can be freely used for other purposes.

As a technical solution, the distance between the diffusing screen and the rotatable table is movable or the system includes two or more diffusing screens capable of being cut in and out.

As a technical solution, the system includes one or more optical radiation probes that directly receive the light emitted by the measured luminaire, where the optical radiation probes include, but are not limited to, illuminance probes, radiation probes, rapid photometric detectors, and/or spectral radiometers and sampling devices thereof; and the optical radiation probe are in communication connection with the data transmission and reception control unit.

As a technical solution, the system includes an alignment laser that creates characteristic lines on the diffusing screen for aligning the measured luminaire. Specifically, the alignment laser can be arranged at the center axis of the measured luminaire on the rotatable table, and the alignment laser can be removed during measurement; or the alignment laser can emit two beams of laser perpendicular to each other to form a plane parallel to the diffusing screen, and the line connecting the reference center of the measured luminaire and the intersection of the two beams of intersecting laser is perpendicular to the diffusing screen.

As a technical solution, a calibration light source with stable light output is arranged in the rotatable table. The system for measuring the spatial light field of the luminaire is calibrated through the calibration light source with known luminous intensity and/or luminance, further ensuring the measurement accuracy. Further, the luminous intensity and/or correlated color temperature of the calibration light source are adjustable.

As mentioned above, an illuminance distribution measurement value of the measured luminaire in one pose is calculated as follows: performing coordinate transformation based on the pose information of the measured luminaire, calculating a spatial angle corresponding to each point on the diffusing screen with the reference center of the measured luminaire as the origin, calculating a distance between each point on the diffusing screen and the reference center of the measured luminaire, calculating a corresponding luminous intensity value based on the inverse square law, obtaining the spatial luminous intensity distribution of the measured luminaire in a local angular interval corresponding to the pose; and integrating the obtained spatial luminous intensity distributions in the local angular intervals in all poses to obtain the full spatial luminous intensity distribution. The data transmission and reception control unit may be configured to perform this process. Input data to the data transmission and reception control unit is one or more illuminance distribution measurement value(s) of the measured luminaire in one or more pose(s) respectively, and output data from the data transmission and reception control unit is luminous intensity value. The input data may include measurement values obtained by one or more imaging measurement device(s). For example, the measurement value obtained by the first imaging measurement device is input data, and the measurement value obtained by the second measurement device is also input data.

As a technical solution, the data transmission and reception control unit may be configured to integrate the light-emitting surface images of the measured luminaire in different poses and the illuminance distributions on the diffusing screen; the data transmission and reception control unit may further be configured to calculate a full spatial luminous intensity distribution of the measured luminaire.

As a technical solution, the data transmission and reception control unit may function as follows:

In the process of integrating the luminous intensity distributions in the local angular intervals in different poses into the full spatial luminous intensity distribution, efficient integration through four strategies should be achieved: multi-source data registration, coordinate system mapping, overlap region fusion, and high-resolution interpolation.

Firstly, a unified coordinate system may be used to build a global and local mapping basis: The premise of integration is to map all local measured data to the same coordinate system. The world coordinate system (with the rotation center of the rotatable table as the origin O and the center normal direction of the diffusing screen as the reference direction) is usually used as a global reference system, while the local coordinate system of the luminaire in each pose (with the reference center C of the luminaire as the origin and the normal of the light-emitting surface as the local \(z′\) axis) is associated with the world coordinate system through pose parameters. Each pixel on the diffusing screen corresponds to a local spatial angle, which will be transformed into a global angle in the world coordinate system through matrix transformation; the stray light eliminating device limits the field of view of the local angular interval for each measurement; if the local intervals in different poses do not overlap or partially overlap in the global space, the overlap regions need to be fused.

Secondly, data registration is performed to achieve spatial alignment of multi-source data: Integration requires one-to-one correspondence between local luminous intensity data in different poses and target positions in the global coordinate system, and its core is pixel-level coordinate registration. It comprises calibrating the first imaging measurement device and the second imaging measurement device, building a coordinate mapping relationship, and building a mapping relationship between pixels of the light-emitting surface and actual spatial coordinates, where the light-emitting surface images obtained by the second imaging measurement device include light-emitting surface information of the luminaire.

The Detailed Description of the Embodiments below provides a specific implementation embodiment of the data transmission and reception control unit in terms of performing the calculation processes and steps. See step B3 described in Detailed Description of the Embodiments.

Beneficial effects of the present invention are as follows: The present invention provides a method and system for measuring the spatial light field of a luminaire, where illuminance distributions on illuminated surfaces within various local angular intervals and light-emitting surface images at various angles are measured, analyzed, and calculated to obtain complete spatial light field information of the measured luminaire. Because only the illuminance distributions in local regions are measured, stray light interference caused by secondary reflection can be greatly reduced, thereby greatly improving the measurement accuracy of luminous intensity. Meanwhile, combined with the light-emitting surface images at various angles, the illuminance distribution on any illuminated surface can be further analyzed, achieving accurate, fast, and complete spatial light field measurement of the luminaire.

### BRIEF DESCRIPTION OF THE DRAWINGS

FIG. 1 is a schematic diagram of illuminance distribution measurement according to the present invention;

FIG. 2 is another schematic diagram of illuminance distribution measurement according to the present invention;

FIG. 3 is a schematic diagram of a measurement principle for calculating illuminance through a bidirectional reflection/transmission distribution function according to the present invention;

FIG. 4 is a schematic diagram of a panoramic structure of a system for measuring the spatial light field of a luminaire according to a first embodiment of the present invention;

FIG. 5 is a side view of the system for measuring the spatial light field of the luminaire according to the first embodiment of the present invention;

FIG. 6 is a schematic diagram of a panoramic structure of a system for measuring the spatial light field of a luminaire according to a second embodiment of the present invention; and

FIG. 7 is a side view of the system for measuring the spatial light field of the luminaire according to the second embodiment of the present invention.

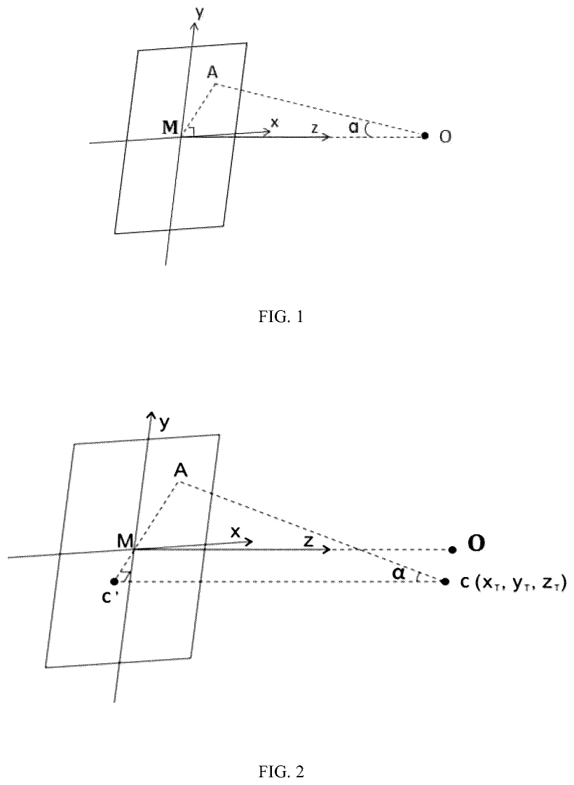

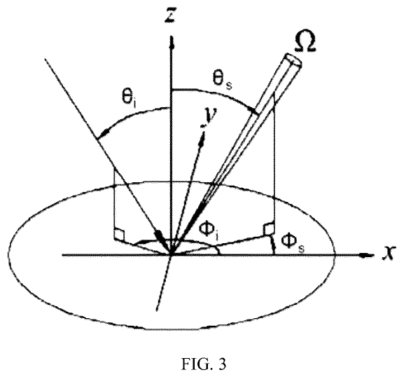

In the figures: 1—measured luminaire, 2—rotatable table, 3—diffusing screen, 4—first imaging measurement device, 5—second imaging measurement device, 6—stray light eliminating aperture, 7—third imaging measurement device, 8—alignment laser, 9—shading tunnel, 10—optical radiation probe, 10-1—photometric probe, and 10-2—spectrometer receiver.

### DETAILED DESCRIPTION OF THE EMBODIMENTS

### First Embodiment

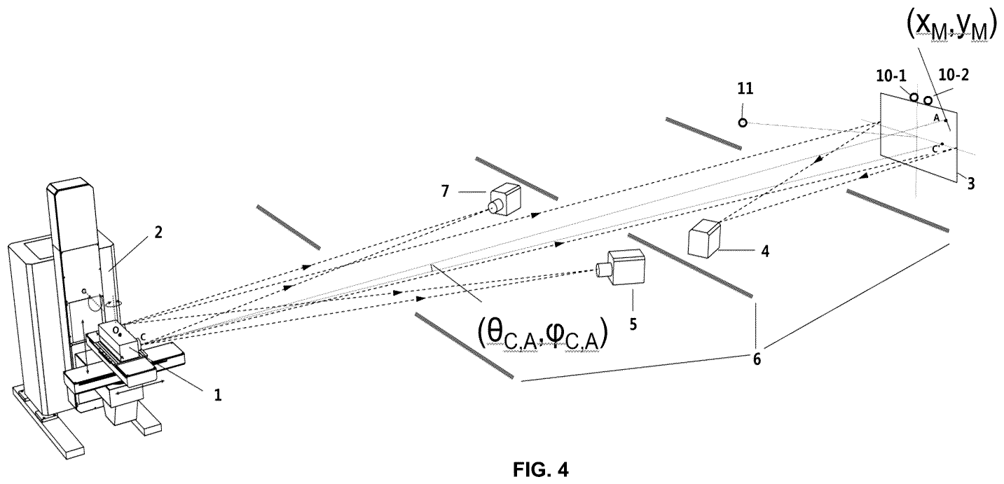

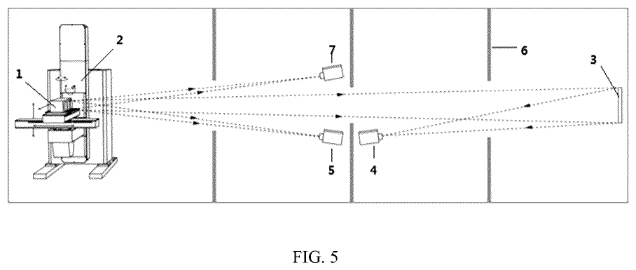

This embodiment provides a system for measuring the spatial light field of a luminaire, as shown in FIG. 4 and FIG. 5, including a rotatable table 2 for installing a measured luminaire 1, a diffusing screen 3 arranged opposite to the rotatable table 2 and satisfying the inverse square law, a first imaging measurement device 4, a second imaging measurement device 5, a third imaging measurement device 7, a photometric probe 10-1, and a spectrometer receiver 10-2. This system further includes a data transmission and reception control unit, an alignment laser 8, and a calibration light source arranged in the rotatable table. The rotatable table 2, the first imaging measurement device 4, the second imaging measurement device 5, the third imaging measurement device 7, the photometric probe 10-1, and the spectrometer receiver 10-2 are all in communication connection with the data transmission and reception control unit. The calibration light source is arranged on the rotatable table 2, and a light outlet of the calibration light source is aligned with the diffusing screen 3 for calibrating the system for measuring the spatial light field of the luminaire. The diffusing screen 3 in this embodiment is a diffuse reflection screen, and the first imaging measurement device 4 is arranged in the space between the diffusing screen 3 and the rotatable table 2 and aligned with the diffusing screen 3, to measure an illuminance distribution of a light spot produced by the measured luminaire and projected onto the diffusing screen 3, so as to obtain a luminous intensity distribution within a local spatial angular interval. The rotatable table 2 drives the measured luminaire 1 to rotate about a horizontal axis and a vertical axis, for switching between different angular intervals to be incident on the diffusing screen 3. Three stray light eliminating apertures 6 are provided between the rotatable table 2 and the diffusing screen 3. The light hole of the stray light eliminating aperture 6 is slightly greater than the flare angle of the line connecting the edge of a maximum measurable light-emitting surface and the edge of a measurement region of the diffusing screen 3.

In this system, the horizontal rotation axis of the rotatable table 2 coincides with the center normal of the diffusing screen, and the distance between a rotation center of the rotatable table 2 and a center of the diffusing screen is known. The first imaging measurement device 4, the second imaging measurement device 5, and the third imaging measurement device 7 are always immobile, and their spatial coordinates relative to the rotation center of the rotatable table are known. The alignment laser 8 generates cross laser, and its center is aligned with the center of the diffusing screen. With the assistance of the alignment laser, the first imaging measurement device 4 is aligned with the diffusing screen, the corresponding relationship between the coordinates (i₁, j₁) of each pixel and the coordinates (x_{M}, y_{M}) of each point on the diffusing screen is calibrated one by one, and the angle (θ₁ₛ, φ₁ₛ) between the direction of light collected by each pixel and the normal direction of the diffusing screen has been accurately calculated based on the tilt angle of the first imaging measurement device 4 and the deviation between the pixel position and the optical axis. The optical axes of the second imaging measurement device 5 and the third imaging measurement device 7 are aligned with the rotation center of the rotatable table, and each pixel of the second imaging measurement device 5 is calibrated by luminance response.

Specific method steps for measuring the spatial light field distribution through the above system are as follows:

A1: Calibrate the first imaging measurement device with the calibration light source, where the light spot of the calibration light source covers the measurement region on the diffusing screen, and the illuminance distribution on the diffusing screen is known and can be verified by the photometric probe arranged on one side of the diffusing screen. A2: Install the measured luminaire onto the rotatable table, where the measured luminaire is a through type headlight, two headlights are located on a mechanical part and are inseparable, and the alignment laser illuminates the diffusing screen and lights up one headlight; and adjust the rotatable table to align a cut-off line of a light spot of the headlight with the laser to determine a direction of the headlight(0,0). Generally, a reference center C of the headlight coincides with the rotation center O. However, due to the limited translation space of the rotatable table, there is a distance between the reference center C and the rotation center O. The second imaging measurement device is used to determine the distance between C and O. Meanwhile, the angle of the headlight is adjusted again through the alignment laser, so that the direction of the headlight (0,0) corresponds to a projection point C′ of the reference center C on the diffusing screen.

A3: Start measurement sampling, where the light of the measured luminaire within a local angular interval illuminates the diffusing screen, and the remaining light is blocked by the stray light eliminating apertures; align the first imaging measurement device with the diffusing screen to measure the illuminance distribution of the diffusing screen; and align the second imaging measurement device with the measured luminaire to obtain a luminance image of the light-emitting surface of the measured luminaire; rotate the measured luminaire through the rotatable table to change the pose of the measured luminaire, where the angular interval for measurement sampling is not greater than the flare angle of the diffusing screen relative to the rotation center, and the angular interval for measurement sampling covers the luminous space of the measured luminaire of interest. In the specific rotation measurement process, preliminary image recognition and analysis are carried out based on the illuminance distribution on the diffusing screen 3 that is collected by the first imaging measurement device 4. When there is a drastic change in luminance and darkness in the obtained illuminance distribution, the rotatable table is controlled to rotate, so that bright and dark regions are illuminated separately as much as possible on the diffusing screen for measurement. When the first imaging measurement device 4 and the second imaging measurement device 5 carry out sampling, reference is made to the rapid illuminance change obtained by the photometric probe 10-1, and an integer multiple of a luminaire modulation period is selected as sampling integration time.

A4: Integrate the light-emitting surface images of the measured luminaire in different poses and the illuminance distributions on the diffusing screen to calculate a full spatial luminous intensity distribution of the measured luminaire.

In step A4, because the illuminance of the first imaging measurement device has been calibrated by the calibration light source, the illuminance distribution of each point on the diffusing screen can be directly obtained. However, due to the distance between the reference center C of the measured luminaire and the rotation center O of the rotatable table, every time the measured luminaire rotates a certain distance, the position of the reference center changes to (x_{w,c}, y_{w,c}, z_{w,c}). Because the initial angle direction of the measured luminaire is parallel to the center axis of the system, the angle of the measured luminaire in the world coordinate system remains consistent with the rotation angle of the rotatable table at (ε, η). The position coordinates of the reference center C are calculated as follows:

$$( [ \begin{matrix}{x}_{W , C} \\ {y}_{W , C} \\ {z}_{W , C}\end{matrix} ] ) = [ \begin{matrix}cos ε & - sin ε & 0 \\ sin ε & cos ε & 0 \\ 0 & 0 & 1\end{matrix} ] \cdot [ \begin{matrix}cos η & & sin η \\ 0 & 1 & 0 \\ - sin η & 0 & cos η\end{matrix} ] \cdot ( {x}_{W 0} , {y}_{W 0} , {z}_{W 0} )$$

The illuminance distribution on the diffusing screen is transformed into a luminous intensity distribution with the reference center C as the origin through the following equation:

$$I ( {θ}_{C , A} , {φ}_{C , A} ) = \frac{E ( {x}_{M , A} , {y}_{M , A} ) \cdot {( d - {z}_{W , C} )}^{2}}{{cos}^{3} α}$$

Where (θ_{C,A}, φ_{C,A}) represents a direction corresponding to any point A on the diffusing screen with the reference center as the origin, obtained by adding the (ε, η) and a vector in the [symbol] direction. [symbol] obtained by calculating the position of point A through (α, β), where α and β can be obtained through the following equations:

$$α = arctan \frac{\sqrt{Δ {x}_{A {C}^{′}}^{2} + Δ {y}_{A {C}^{′}}^{2}}}{d - {z}_{W , C}} \\ β = arctan \frac{Δ {y}_{A {C}^{′}}}{Δ {x}_{A C ′}}$$

Where Δx_{AC}, and Δy_{AC′} represent coordinate differences between point A and point C′, respectively.

A5: Further derive full ray set information of the measured luminaire based on the luminance images measured by the second imaging measurement device in all directions. A specific method is as follows:

With the reference center of the measured luminaire as the origin, the coordinates of a point through which ray data corresponding to any pixel P in the second imaging measurement device passes are (x_{C,2},y_{C,2},z_{C,2}), the ray direction is represented as (θ_{C,P}, φ_{C,P}), and the ray flux is represented asdΦ_{C,P}.

Specific equations are as follows:

$${x}_{C , 2} = {d}_{2} \cdot sin ( {θ}_{W , 2} + ε ) cos ( {φ}_{W , 2} + η ) - {x}_{W , C} \\ {y}_{C , 2} = {d}_{2} \cdot sin ( {θ}_{W , 2} + ε ) sin ( {φ}_{W , 2} + η ) - {y}_{W , C} \\ {y}_{C , 2} = {d}_{2} \cdot cos ( {θ}_{W , 2} + ε ) - {z}_{W , C}$$

The ray direction is obtained by summing a direction vector of pixel coordinates relative to an exit pupil and a direction vector of the second imaging measurement device relative to the rotation center, and then transforming the left of the sum to the coordinate system with the reference center C of the measured luminaire as the origin.

The ray flux is calculated through the following equation:

$$d {Φ}_{C , P} = L ( {i}_{2 , P} , {j}_{2 , P} ) \cdot dA ( {x}_{W , 2} , {y}_{W , 2} , {z}_{W , 2} ) \cdot d Ω ( {i}_{2 , P} , {j}_{2 , P} )$$

Where (i_{2,P}, j_{2,P}) represents pixel coordinates corresponding to point P, dA(x_{W,2}, y_{W,2}, z_{W,2}) represents corresponding surface element area at that angle and is related to the rotation interval of the rotatable table, and dA(x_{W,2}, y_{W,2}, z_{W,2}) represents a solid angle element corresponding to the pixel, calculated by pixel size and position.

In this embodiment, in order to obtain more accurate full ray set information, the sampling angular interval of the second imaging measurement device can be reduced. In a case of limited measurement sampling, richer information can be obtained through luminance image interpolation.

A6: Further derive and calculate other photometric parameters after obtaining full ray set data. For example, the luminous intensity corresponding to any point A on the diffusing screen and the illuminance value of a certain surface element can be calculated through the following equations, respectively:

$$I ( {ϑ}_{C , A} , {φ}_{C , A} ) = \frac{{Σ}_{{x}_{C} , {y}_{C} , {z}_{C}} Δ Φ ( {x}_{C} , {y}_{C} , {z}_{C} , {θ}_{C} , {φ}_{C} )}{ΔΩ ( {ϑ}_{C , A} , {φ}_{C , A} )} ∀ θ , φ ∈ ΔΩ ( {ϑ}_{C , A} , {φ}_{C , A} ) \\ E ( {x}_{M , A} , {y}_{M , A} ) = \frac{\sum Δ ( {x}_{C} , {y}_{C} , {z}_{C} , {θ}_{C} , {φ}_{C} )}{Δ A} ∀ ( {x}_{C} , {y}_{C} , {z}_{C} , {θ}_{C} , {φ}_{C} )$$

intersects with ΔA within the surface element. ΔΩ(ϑ_{C,A}, φ_{C,A}) represents a solid angle element of a luminous intensity direction corresponding to point A on the diffusing screen.

The corresponding luminous intensity and illuminance at the location of the photometric probe can also be derived by the same method. Therefore, the measurement values of the second imaging measurement device can be further corrected or verified through the photometric values measured by the first imaging measurement device or the photometric probe.

### Second Embodiment

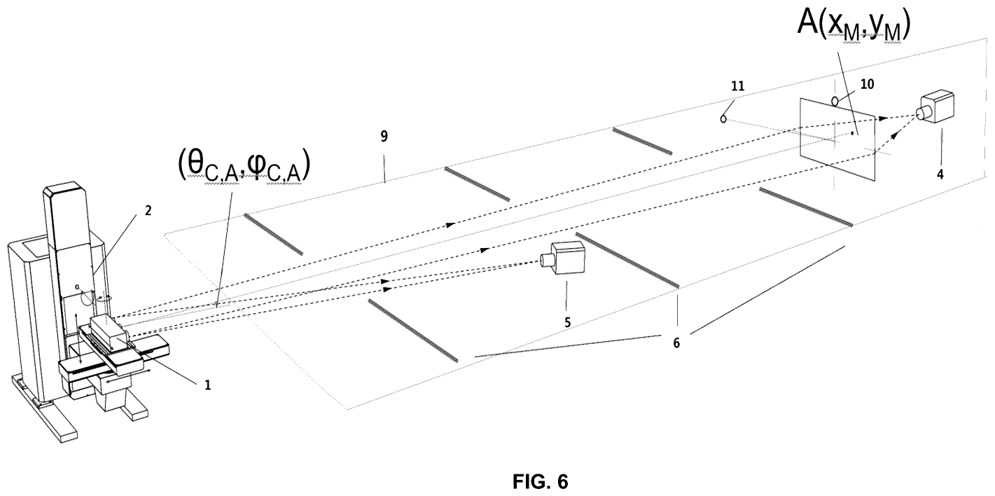

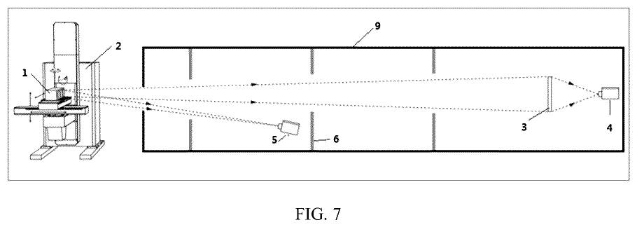

This embodiment provides another system for measuring the spatial light field of a luminaire, as shown in FIG. 6 and FIG. 7, including a rotatable table 2 for installing a measured luminaire 1, a diffusing screen 3 arranged opposite to the rotatable table 2 and satisfying the inverse square law, a first imaging measurement device 4, a second imaging measurement device 5, an optical radiation probe 10, an alignment laser 8, and a data transmission and reception control unit. The diffusing screen 3 is a diffuse transmission screen. The first imaging measurement device 4 is arranged at a position remote from the rotatable table 2 beyond the diffusing screen 3 and aligned with the diffusing screen 3, to measure light spot information on the diffusing screen 3 within a certain angular interval and obtain an illuminance distribution. The rotatable table 2, the first imaging measurement device 4, the second imaging measurement device 5, and the optical radiation probe 10 are all in communication connection with the data transmission and reception control unit. The rotatable table 2 drives the measured luminaire 1 to rotate and switch between different angular regions to be incident on the diffusing screen 3. The rotatable table 2 can move up and down, left and right, and forward and backward to align a reference center C of the measured luminaire with a rotation center O of the rotatable table 2. Three detachable stray light eliminating apertures 6 are provided between the rotatable table 2 and the diffusing screen 3. The light hole of the stray light eliminating aperture 6 is slightly greater than the flare angle of the line connecting the edge of a maximum measurable light-emitting surface and the edge of a measurement region of the diffusing screen 3. The alignment laser 8 can emit two beams of laser perpendicular to each other, and the intersection of the laser is located at the center of diffusing screen 3. This system includes a shading tunnel 9. The stray light eliminating apertures 6, the diffusing screen 3, the first imaging measurement device 4, and the second imaging measurement device 5 are all located in the shading tunnel 9, thereby further reducing stray light interference and improving the utilization of laboratory space.

In this system, the horizontal rotation axis of the rotatable table 2 coincides with the center normal of the diffusing screen, and the distance between the rotation center of the rotatable table 2 and the center of the diffusing screen is known. The first imaging measurement device 4 and the second imaging measurement device 5 are always immobile, and their spatial coordinates relative to the center of the rotatable table are known. With the assistance of the alignment laser, the first imaging measurement device 4 is aligned with the diffusing screen, the corresponding relationship between the coordinates (i₁, j₁) of each pixel and the coordinates (x_{M}, y_{M}) of each point on the diffusing screen is calibrated one by one, and the angle (θ₁ₛ, φ₁ₛ) between the direction of light collected by each pixel and the normal direction of the diffusing screen has been accurately calculated based on the tilt angle of the first imaging measurement device 4 and the deviation between the pixel position and the optical axis. The optical axis of the second imaging measurement device 5 is aligned with the rotation center of the rotatable table 2, and each pixel of the second imaging measurement device 5 is calibrated by luminance response.

Specific method steps for measuring the spatial light field distribution through the above system are as follows:

B1: Install the measured luminaire on the rotatable table, adjust the rotatable table to ensure that the reference center C of the measured luminaire coincides with the rotation center O, and observe the position of the reference center C in a luminance image obtained by the second imaging measurement device 5, ensuring that the reference center C of the luminaire is always at a center position of the luminance image; observe a light spot on the diffusing screen with the assistance of the alignment laser, where the direction of the measured luminaire (0,0) coincides with the optical axis of the system, i.e. the center normal direction of the diffusing screen.

B2: Start measurement sampling, where the light of the measured luminaire within a local angular interval illuminates the diffusing screen 3, and the remaining light is blocked by the shading tunnel and the stray light eliminating apertures; align the first imaging measurement device 4 with the diffusing screen 3 to measure the illuminance distribution of the diffusing screen; align the second imaging measurement device 5 with the measured luminaire 1 to obtain a luminance image of a light-emitting surface of the measured luminaire 1; rotate the measured luminaire 1 through the rotatable table 2 to change the pose of the measured luminaire, where the angular interval for measurement sampling is not greater than the flare angle of the diffusing screen relative to the rotation center, and the angular interval for measurement sampling covers the luminous space of the measured luminaire of interest. In the specific rotation measurement process, preliminary image recognition and analysis are carried out based on the illuminance distribution on the diffusing screen 3 that is collected by the first imaging measurement device 4. When there is a drastic change in luminance and darkness in the obtained illuminance distribution, the rotatable table is controlled to rotate, so that bright and dark regions are illuminated separately as much as possible on the diffusing screen for measurement. When the first imaging measurement device 4 and the second imaging measurement device 5 carry out sampling, reference is made to the rapid illuminance change obtained by the optical radiation probe 10, and an integer multiple of a luminaire modulation period is selected as sampling integration time.

B3: Integrate the light-emitting surface images of the measured luminaire in different poses and the illuminance distributions on the diffusing screen to calculate a full spatial luminous intensity distribution of the measured luminaire.

In step B3, (x_{M},y_{M}) represents coordinates of a point on the diffusing screen, and a zenith angle and an azimuth angle (θᵢ, φᵢ) in the corresponding direction of incident light ωᵢ can be calculated based on the coordinates (x_{M},y_{M}) and the distance between the center of the measured luminaire and the diffusing screen, that is,

$${θ}_{i} = arctan ( \frac{\sqrt{{x}_{M}^{2} + {y}_{M}^{2}}}{{d}_{M}} ) , {φ}_{i} = arctan ( \frac{{y}_{M}}{{x}_{M}} ) ;$$

a zenith angle and an azimuth angle (θ₁ₛ, φ₁ₛ) in the corresponding direction of scattered light ωₛ have been calibrated through pixel coordinates, and can also be calculated as follows:

$${θ}_{1 s} = arctan ( \frac{\sqrt{{x}_{M}^{2} + {y}_{M}^{2}}}{s} ) , {φ}_{1 s} = arctan ( \frac{{y}_{M}}{{x}_{M}} ) ,$$

where s represents the distance between the diffusing screen and the entrance pupil of the first imaging measurement device; according to the equation

$$E ( x , y ) = \frac{L ( x , y ) \cdot π}{ρ ( {ω}_{i} , {ω}_{s} )} ,$$

the illuminance value produced by the measured luminaire on the equation the diffusing screen 3 is calculated, where ρ(ωᵢ, ωₛ) represents a bidirectional scattering function for the diffusing screen. According to the equation I(x_{M},y_{M})=E(x_{M},y_{M}). dₘ²/cos₃α, the luminous intensity distribution corresponding to each point is calculated, where α represents an angle between the central axis of the system and the line connecting the position (x_{M},y_{M}) and the center of the rotatable table. The position (x_{M},y_{M}) is related to the incident angle. When the rotation angle of the rotatable table is (ε, η), the spatial angle corresponding to (x_{M},y_{M}) is (ε+α, η+β), where

$$β = arctan \frac{{y}_{M}}{{x}_{M}} .$$

B4: Calculate full ray set information of the measured luminaire based on the luminance images obtained by the second imaging measurement device at all angles. The calculation method is similar to that in the first embodiment, but its calculation process is relatively simple because the reference center of the measured luminaire is located at the rotation center.

B5: Calculate more spatial photometric distributions of interest through full ray set data, including illuminance values at the optical radiation probe 10, and correct absolute values of the ray set data through the measurement values of the optical radiation probe; calculate an illuminance distribution of the diffusing screen at a certain rotation angle through the full ray set data, and verify relative values with the measurement values of the first imaging measurement device to ensure the accuracy of the full ray set data.

Preferably, the angular resolution of each region within the field of view of the first imaging measurement device and/or the second imaging measurement device at a working distance is measured, and the measurement values within the angular resolution range of all regions are merged and averaged in steps B3 and B4. The angular resolution that can be achieved by the method in this embodiment during measurement is not equivalent to the pixels of the imaging measurement device, but more related to the angular resolution of the entire optical system. High pixels do not represent high resolution, but instead increase useless information and occupy a large amount of memory. An angular resolution map card is set on the surface of the diffusing screen, and the imaging measurement device is used to obtain images for analyzing a minimum distinguishable line pair 1 p/mm. The angular resolutions of the imaging measurement device in various regions of the diffusing screen are obtained through the line pair based on a trigonometric function (there may be differences in the center and periphery). In the actually obtained illuminance distribution, the pixel responses within the distinguishable angular interval are merged and calculated based on the angular resolutions, where the illuminance is represented by an average value of pixels within the interval, and the angle may be a center value.

The specific embodiments of the present invention are described above in conjunction with the accompanying drawings, but those skilled in the art should understand that the above embodiments are only for illustration and not to limit the scope of the present invention. Those skilled in the art should understand that modifications can be made to the above embodiments without departing from the scope and spirit of the present invention. The scope of protection of the present invention is defined by the appended claims.

1. A method for measuring the spatial light field of a luminaire, wherein illuminance distributions on illuminated surfaces within two or more local angular intervals in the far-field of a measured luminaire are measured and integrated to obtain full spatial light field information of the measured luminaire, wherein specific steps are as follows:
S1: installing the measured luminaire on a rotatable table, wherein only a portion of light emitted by the measured luminaire illuminates a diffusing screen in the far-field space, while the remaining light is blocked by a stray light eliminating device;
S2: aligning a first imaging measurement device with the diffusing screen to measure the illuminance distribution thereon, and aligning a second imaging measurement device with the measured luminaire to obtain a light-emitting surface image of the measured luminaire;
S3: rotating the measured luminaire through the rotatable table to change the pose of the measured luminaire, and repeating step S2 for measurement in two or more poses; and
S4: integrating the light-emitting surface images of the measured luminaire in different poses and the illuminance distributions on the diffusing screen to calculate a full spatial luminous intensity distribution of the measured luminaire.

2. The method for measuring the spatial light field of the luminaire according to claim 1, wherein in step S3, the rotatable table provides rotation information of the measured luminaire; and in step S4, pose information of the measured luminaire is calculated by combining the rotation information of the measured luminaire and analysis on the light-emitting surface images, that is, corresponding pose information of the measured luminaire when the first imaging measurement device measures the illuminance distributions in local angular intervals is obtained.

3. The method for measuring the spatial light field of the luminaire according to claim 1, wherein in step S4, an illuminance distribution measurement value of the measured luminaire in one pose is calculated as follows: performing coordinate transformation based on the pose information of the measured luminaire, calculating a spatial angle corresponding to each point on the diffusing screen with a photometric center of the measured luminaire as an origin, calculating a distance between each point on the diffusing screen and the photometric center of the measured luminaire, calculating a corresponding luminous intensity value based on the inverse square law, obtaining the spatial luminous intensity distribution of the measured luminaire in a local angular interval corresponding to the pose; and integrating the obtained spatial luminous intensity distributions in the local angular intervals in all poses to obtain the full spatial luminous intensity distribution.

4. The method for measuring the spatial light field of the luminaire according to claim 1, wherein in step S4, the light-emitting surface image of the measured luminaire in one pose is calculated as follows: converting the light-emitting surface image into regional ray set information composed of several ray data, wherein the ray data comprises a ray direction, position coordinates of a point in ray, and a ray flux; and integrating the corresponding regional ray set information in all poses to obtain full ray set information.

5. The method for measuring the spatial light field of the luminaire according to claim 4, wherein the ray data corresponds to pixels in the light-emitting surface image; the ray direction is determined based on the pose information of the measured luminaire, the pose of the second imaging measurement device, and pixel coordinates in the second imaging measurement device; the position coordinates of the point in the ray are determined by the pose information of the measured luminaire and the pose of the second imaging measurement device; and the ray flux is determined by pixel response, pixel area, and a spatial angle.

6. The method for measuring the spatial light field of the luminaire according to claim 4, wherein in step S4, photometric parameters are derived and calculated based on the full ray set information of the measured luminaire, wherein the photometric parameters comprise illuminance distribution of a specified surface, spatial luminous intensity distribution, and total luminous flux or regional luminous flux.

7. The method for measuring the spatial light field of the luminaire according to claim 6, wherein in step S4, measurement values of the first imaging measurement device are compared with the photometric parameters derived and calculated from the full ray set information, and the full ray set information is corrected based on the comparison results.

8. The method for measuring the spatial light field of the luminaire according to claim 1, wherein one or more optical radiation probes are further used to receive light from the measured luminaire; a same calibration light source or the measured luminaire is measured by the optical radiation probes, the first imaging measurement device, and the second imaging measurement device, respectively; and measurement or calculation values of the first imaging measurement device and/or the second imaging measurement device are calibrated against the measurement or calculation values of the optical radiation probes.

9. The method for measuring the spatial light field of the luminaire according to claim 1, wherein a speed photometer is used to measure changes of illuminance over time, so as to calculate a light modulation period, wherein measurement integration time of the first imaging measurement device and/or the second imaging measurement device is an integer multiple of the modulation period.

10. The method for measuring the spatial light field of the luminaire according to claim 1, wherein the first imaging measurement device has a chromaticity measurement function and outputs chromaticity of each point on the diffusing screen in the measurements of steps S2 and S3, and varying chromaticity parameters over spatial angle are calculated in step S4.

11. The method for measuring the spatial light field of the luminaire according to claim 1, wherein a bidirectional scattering distribution function of the diffusing screen is obtained, and a diffuse illuminance distribution obtained by the first imaging measurement device is corrected through the bidirectional scattering distribution function.

12. The method for measuring the spatial light field of the luminaire according to claim 1, wherein a third imaging measurement device at a certain distance from the second imaging measurement device is further used, the third imaging measurement device is aligned with the measured luminaire at another position to obtain auxiliary light-emitting surface images of the measured luminaire, and the pose information of the measured luminaire is further recognized and analyzed through the auxiliary light-emitting surface images.

13. The method for measuring the spatial light field of the luminaire according to claim 1, wherein during the scanning measurement process in step S3, there is an overlap region between two measurements of the first imaging measurement device; and in step S4, illuminance distribution data of the overlap region is analyzed, and error factors are analyzed and corrected, wherein the error factors comprise stray light, light blocking, or angular accuracy.

14. A system for measuring the spatial light field of a luminaire, comprising a rotatable table (2) for installing a measured luminaire (1), a diffusing screen (3) arranged opposite to the rotatable table (2), a first imaging measurement device (4), a second imaging measurement device (5), and a data transmission and reception control unit, wherein the first imaging measurement device (4) is aligned with the diffusing screen (3) for measurement, and the second imaging measurement device (5) is aligned with the measured luminaire (1); two or more groups of stray light eliminating apertures (6) are arranged between the rotatable table (2) and the diffusing screen (3); and the first imaging measurement device (4), the second imaging measurement device (5), and the rotatable table (2) are all in communication connection with the data transmission and reception control unit.

15. The system for measuring the spatial light field of the luminaire according to claim 14, wherein the diffusing screen (3) is a diffuse reflection screen, and the first imaging measurement device is arranged between the diffusing screen and the measured luminaire; or the diffusing screen is a diffuse transmission screen, and the first imaging measurement device is arranged on the side of the diffusing screen that is remote from the measured luminaire.

16. The system for measuring the spatial light field of the luminaire according to claim 14, further comprising a shading tunnel (9), wherein the shading tunnel (9) is arranged between the rotatable table and the diffusing screen, and the stray light eliminating apertures (6) are arranged in the shading tunnel.

17. The system for measuring the spatial light field of the luminaire according to claim 14, comprising one or more optical radiation probes (10) that receive light from the measured luminaire (1), wherein the optical radiation probes comprise illuminance probes, radiation probes, rapid photometric detectors and/or spectral radiometers and sampling devices thereof; and the optical radiation probes are in communication connection with the data transmission and reception control unit.

18. The system for measuring the spatial light field of the luminaire according to claim 14, wherein a calibration light source with stable light output is arranged in the rotatable table.
